(19) United States
(12) Patent Application Publication
(10) Pub. No.: US 2024/0246308 A1
(43) Pub. Date: Jul. 25, 2024

(54) PRODUCTION METHOD FOR GREEN TIRE, PRODUCTION METHOD FOR PNEUMATIC TIRE, PRODUCTION APPARATUS FOR GREEN TIRE, AND PNEUMATIC TIRE

(71) Applicant: Sumitomo Rubber Industries, Ltd., Hyogo (JP)

(72) Inventor: Masashi YAGUCHI, Kobe-shi (JP)

(73) Assignee: Sumitomo Rubber Industries, Ltd., Hyogo (JP)

(21) Appl. No.: 18/419,030

(22) Filed: Jan. 22, 2024

(30) Foreign Application Priority Data
Jan. 23, 2023 (JP) 2023-008358

(51) Int. Cl. B29D 30/72; B60C 13/00

(52) U.S. Cl. CPC B29D 30/72; B60C 13/001; B29D 2030/726

(57) ABSTRACT

Provided is a pneumatic tire that can suppress an increase in weight and deterioration of rolling resistance even when a protrusion-like mark having a large raised height is provided on a sidewall portion. A green tire production method 100 includes: a first step S1 of forming a cylindrical or annular unvulcanized carcass; a second step S2 of winding an unvulcanized sidewall rubber on each of a pair of outer circumferential surfaces of the carcass on an outer side in an axial direction; and a third step S3 of locally attaching an unvulcanized band-shaped rubber to a part of an outer circumferential surface of at least one of the sidewall rubbers.

### BACKGROUND OF THE INVENTION

### Field of the Invention

The present invention relates to a production method for a green tire, a production method for a pneumatic tire, a production apparatus for a green tire, and a pneumatic tire.

### Background Art

Hitherto, a pneumatic tire in which a protrusion-like mark composed of a letter, a symbol, or a figure is formed on a sidewall portion, has been known (see, for example, Japanese Laid-Open Patent Publication No. 2016-210072).

In recent years, in order to enhance the design properties of pneumatic tires, there is a tendency to design protrusion-like marks with a higher raised height. Meanwhile, in the conventional production technology for green tires, each sidewall rubber is molded with a uniform thickness over the entire circumference, so that the rubber thickness may be insufficient in a region where a protrusion-like mark is formed in a vulcanized tire. When a green tire is produced with, as a reference, a rubber thickness in a region where a protrusion-like mark is formed, a rubber thickness in a region where the protrusion-like mark is not formed becomes excessive, resulting in an increase in weight and deterioration of rolling resistance.

The present invention has been made in view of the above circumstances, and a major object of the present invention is to provide a pneumatic tire that can suppress an increase in weight and deterioration of rolling resistance even when a protrusion-like mark having a large raised height is provided on a sidewall portion.

### SUMMARY OF THE INVENTION

The present invention is directed to a production method for producing a green tire, the production method including: a first step of forming a cylindrical or annular unvulcanized carcass; a second step of winding an unvulcanized sidewall rubber on each of a pair of outer circumferential surfaces of the carcass on an outer side in an axial direction; and a third step of locally attaching an unvulcanized band-shaped rubber to a part of an outer circumferential surface of at least one of the sidewall rubbers.

In the green tire production method of the present invention, the band-shaped rubber attached in the third step compensates for a rubber volume that is insufficient at the protrusion-like mark. Accordingly, the rubber thickness in a region where the protrusion-like mark is formed in the vulcanized tire is inhibited from being insufficient. In addition, the rubber thickness in a region where the protrusion-like mark is not formed is appropriately maintained, so that an increase in the weight and deterioration of the rolling resistance of the pneumatic tire are suppressed.

### BRIEF DESCRIPTION OF THE DRAWINGS

FIG. 1 is a meridian cross-sectional view of a pneumatic tire according to one embodiment of the present invention;

FIG. 2 is a perspective view of the pneumatic tire in FIG. 1;

FIG. 3 is a flowchart showing the flow of a production method for a green tire according to one embodiment of the present invention;

FIG. 4 is a perspective view showing a third step in FIG. 3;

FIG. 5 is a perspective view showing the third step, subsequent to FIG. 4;

FIG. 6 is a perspective view showing the third step, subsequent to FIG. 5;

FIG. 7 is a perspective view showing the third step, subsequent to FIG. 6;

FIG. 8 is a flowchart showing the flow of a production method for the pneumatic tire according to one embodiment of the present invention;

FIG. 9 is a plan view showing a fourth step in FIG. 8;

FIG. 10 is a meridian cross-sectional view of a sidewall portion including a first portion in which a protrusion-like mark is formed in the pneumatic tire in FIG. 2; and

FIG. 11 is a meridian cross-sectional view of a sidewall portion including a second portion in which the protrusion-like mark is not formed in the pneumatic tire in FIG. 2.

### DETAILED DESCRIPTION

Hereinafter, embodiments of the present invention will be described with reference to the drawings.

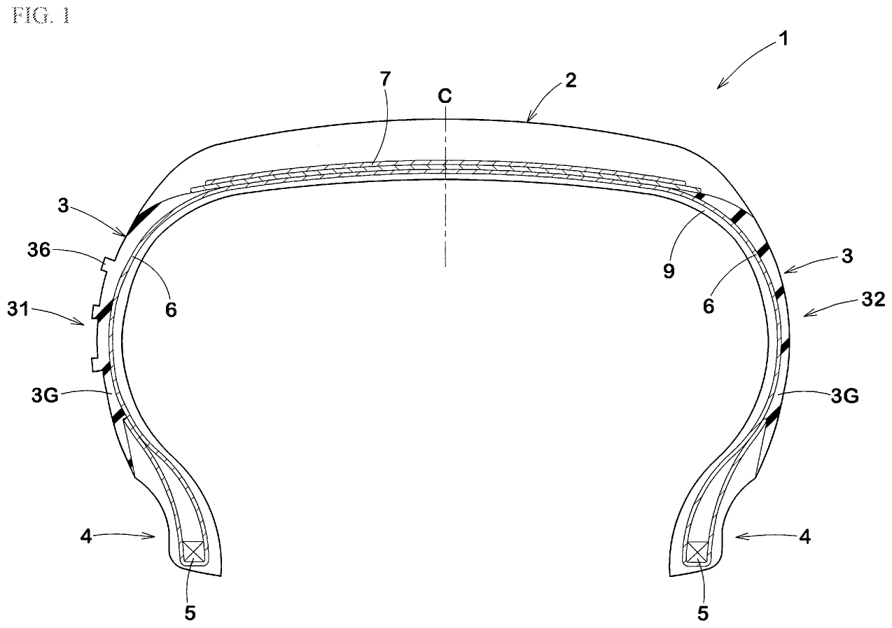

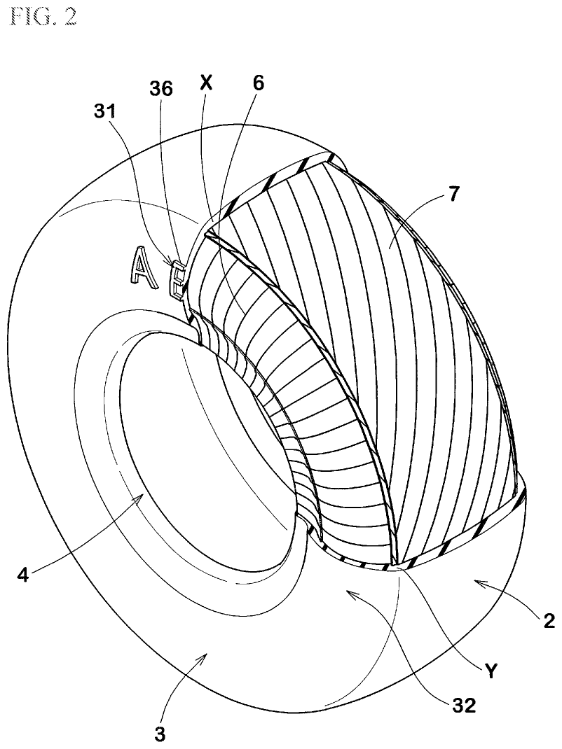

FIGS. 1 and 2 show a pneumatic tire according to one embodiment of the present invention. A pneumatic tire 1 includes a tread portion 2, a pair of sidewall portions 3, and a pair of bead portions 4 in each of which a bead core 5 is embedded.

FIG. 1 shows a meridian cross-section, including the tire axis, of each bead portion 4 of the pneumatic tire 1 in a standardized state where the pneumatic tire 1 is fitted on a standardized rim and inflated to a standardized internal pressure. Hereinafter, unless otherwise specified, dimensions of the pneumatic tire 1 are measured in the standardized state. However, dimensions, of an internal structure, etc., that cannot be measured, are measured in a state approximating the standardized state using a cut section.

The “standardized rim” is a rim R that is defined, in a standard system including a standard on which the tire is based, by the standard for each tire, and is, for example, the “standard rim” in the JATMA standard, the “Design Rim” in the TRA standard, or the “Measuring Rim” in the ETRTO standard. In this application, unless otherwise specified, the rim R is a standardized rim.

The “standardized internal pressure” is an air pressure that is defined, in a standard system including a standard on which the tire is based, by the standard for each tire, and is the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard.

The bead cores 5 are provided in the pair of bead portions 4, respectively. Each bead core 5 is formed, for example, so as to have a polygonal cross-sectional shape by winding a steel bead wire (not shown) in multiple rows and in multiple stages.

Between the pair of bead portions 4, a carcass 6 extends so as to straddle the pair of bead cores 5. The pair of sidewall portions 3 each have a sidewall rubber 3G on the outer side of the carcass 6 in the tire axial direction.

The carcass 6 has at least one carcass ply. The carcass ply is formed, for example, by covering an array of carcass cords with a topping rubber. For example, organic fibers such as polyester fibers, nylon fibers, rayon fibers, polyethylene naphthalate fibers, and aramid fibers, and steel are used for the carcass cords.

In the pneumatic tire 1 of the present embodiment, a belt layer 7 is provided in the tread portion 2. The belt layer 7 is located outward of the carcass 6 in the tire radial direction. The belt layer 7 is composed of at least one belt ply, and is composed of two belt plies on the inner and outer sides in the tire radial direction in the present embodiment. Each belt ply is formed, for example, by covering an array of belt cords with a topping rubber. The belt cords are arranged in the tire circumferential direction. That is, the belt cords are preferably arranged so as to be tilted relative to a tire equator C, for example, at an angle of 15 to 45°. The belt cords are preferably cords having high elasticity, such as steel cords.

A band layer may be provided outward of the belt layer 7 in the tire radial direction. The band layer is composed of at least one band ply in which organic fiber cords are arranged at a small angle, for example, 10 degrees or less, with respect to the tire circumferential direction. The band ply may be obtained by splicing either a jointless band or ply that is formed by helically winding a band cord or a ribbon-like band-shaped ply.

In the pneumatic tire 1 of the present embodiment, an inner liner 9 is provided inward of the carcass 6 in the tire radial direction and the tire axial direction.

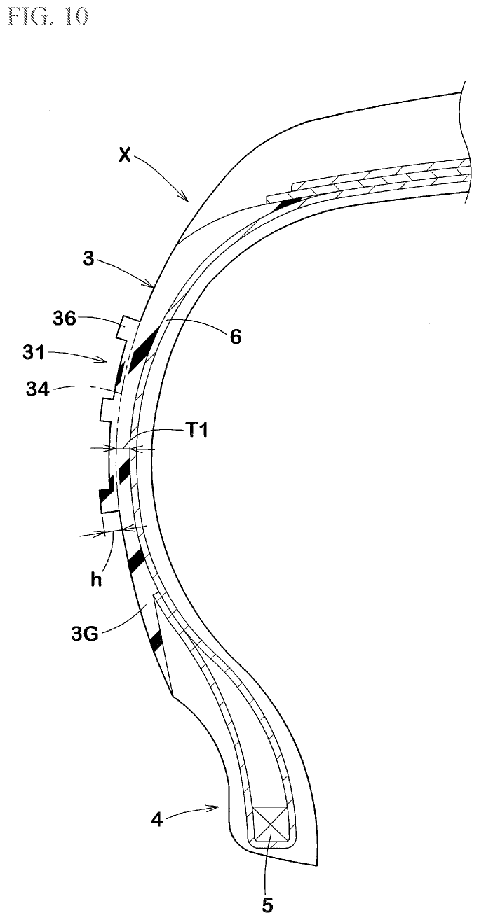

The sidewall portion 3 has a protrusion-like mark 36 composed of letters, symbols, or figures. The protrusion-like mark 36 is formed so as to be raised outward in the tire axial direction from a sidewall virtual contour surface 34 (see FIG. 10 described later) along the outer surface of the carcass 6. The design properties of the pneumatic tire 1 are enhanced by such a protrusion-like mark 36.

The protrusion-like mark 36 of the present embodiment is formed on the pair of sidewall portions 3. The protrusion-like mark 36 may be formed on only one sidewall portion 3.

The protrusion-like mark 36 is formed locally on a portion on the circumference of the sidewall portion 3. Accordingly, the sidewall portion 3 has a first portion 31 in which the protrusion-like mark 36 is formed, and a second portion 32 in which the protrusion-like mark 36 is not formed.

The protrusion-like mark 36 is formed continuously with a specific length in the tire circumferential direction. The protrusion-like mark 36 may be intermittently formed in the tire circumferential direction. The protrusion-like mark 36 may be composed of a series of letters separated from each other by a specific interval.

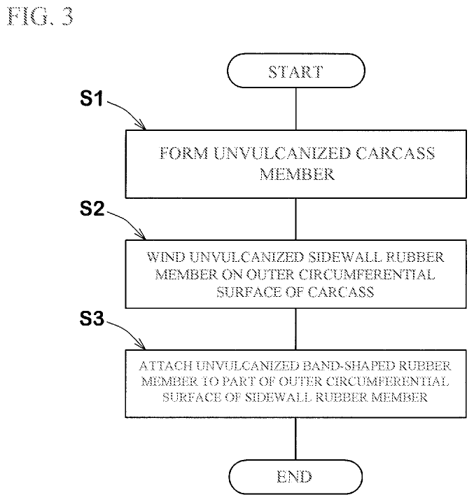

FIG. 3 illustrates a production method for a green tire according to one embodiment of the present invention. The pneumatic tire 1 is produced by vulcanizing and molding a green tire 1g produced by a green tire production method 100.

The green tire production method 100 includes a first step S1 to a third step S3.

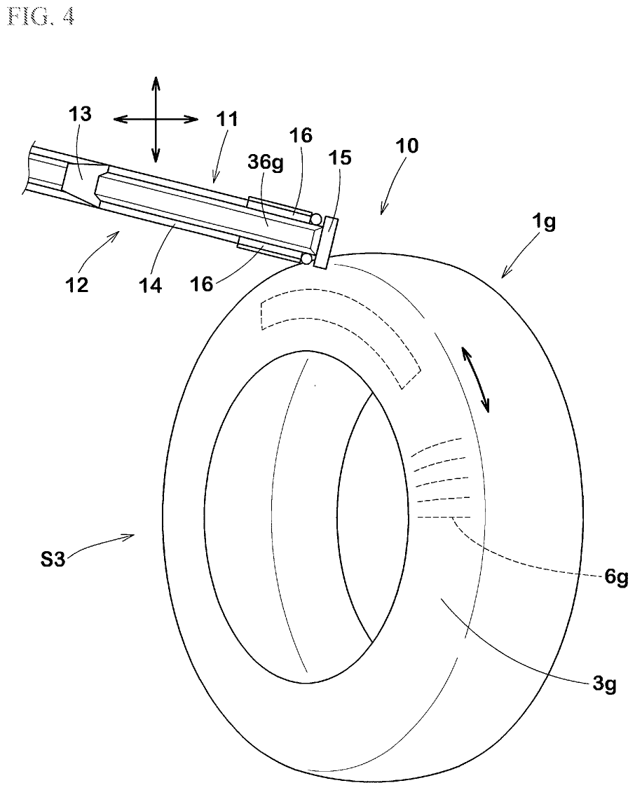

In the first step S1, a cylindrical or annular unvulcanized carcass 6g (see FIG. 4) is formed. In the second step S2, an unvulcanized sidewall rubber 3g is wound on each of a pair of outer circumferential surfaces of the carcass 6g on the outer side in the axial direction. The first step S1 and the second step S2 are the same as those of a conventional green tire production method. Therefore, the first step S1 and the second step S2 can be executed even using a conventional green tire production apparatus.

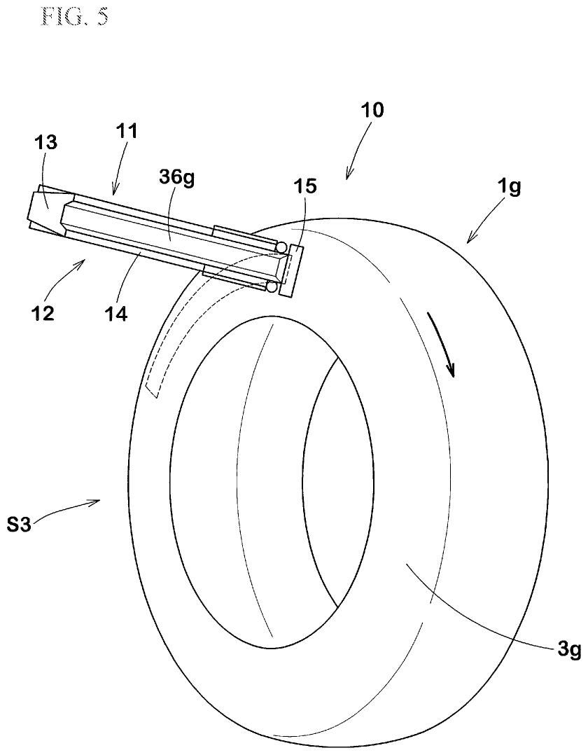

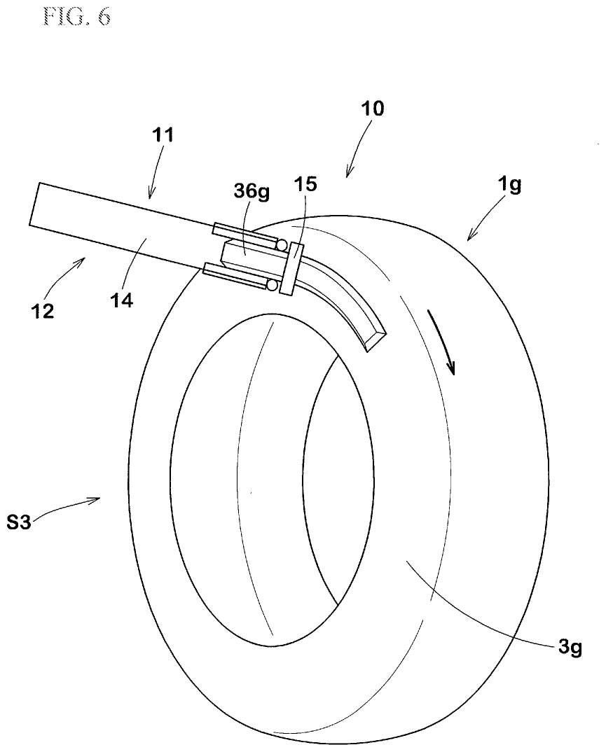

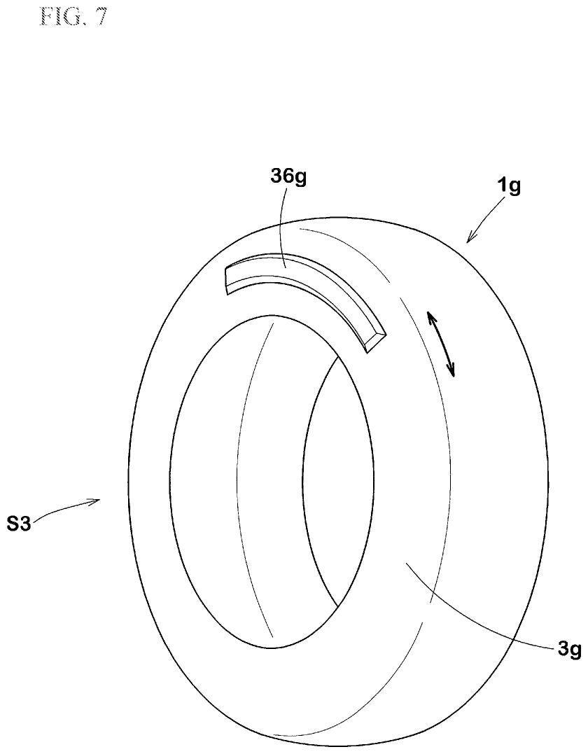

FIG. 4 to FIG. 7 show the third step S3. In the third step S3, an unvulcanized band-shaped rubber 36g is attached to the outer circumferential surface of the sidewall rubber 3g. In FIGS. 4 and 5, a region surrounded by a broken line is a region where the band-shaped rubber 36g is attached in the third step S3.

The length in the tire circumferential direction of the band-shaped rubber 36g corresponds to the length in the tire circumferential direction of the protrusion-like mark 36. In a vulcanization step in which the green tire 1g is vulcanized and molded, the band-shaped rubber 36g flows in a mold. Therefore, the length in the tire circumferential direction of the band-shaped rubber 36g does need to be exactly equal to the length in the tire circumferential direction of the protrusion-like mark 36.

FIG. 4 to FIG. 7 show an example in which one layer of band-shaped rubber 36g is attached to the sidewall portion 3. The band-shaped rubber 36g may be formed by stacking a thinner strip rubber a plurality of times.

In the green tire production method 100, the band-shaped rubber 36g attached in the third step S3 compensates for a rubber volume that is insufficient at the protrusion-like mark 36. Accordingly, the rubber thickness at the first portion 31 in which the protrusion-like mark 36 is formed in the vulcanized tire (pneumatic tire 1) is inhibited from being insufficient. In addition, the rubber thickness at the second portion 32 in which the protrusion-like mark 36 is not formed is appropriately maintained, so that an increase in the weight and deterioration of the rolling resistance of the pneumatic tire 1 are suppressed.

The first step S1 usually includes a step in which unvulcanized tire components including the carcass 6g (e.g., an inner liner, etc.) are attached to the outer circumferential surface of a forming drum.

The first step S1 of the present invention may include a step of attaching the above tire components including the carcass 6g to the outer surface of a rigid core.

The third step S3 of the present invention may be executed before or after an unvulcanized belt member forming the belt layer 7 is wound on the radially outer side of the carcass 6g. In addition, the third step S3 of the present invention may be executed before or after an unvulcanized tread rubber member is wound on the radially outer side of the carcass 6g.

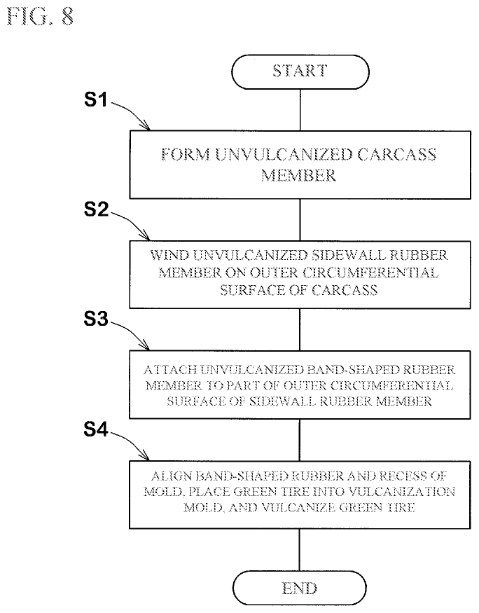

FIG. 8 shows a production method 200 for the pneumatic tire 1 according to one embodiment of the present invention. The production method 200 for the pneumatic tire 1 includes a first step S1 to a fourth step S4.

As already described, the pneumatic tire 1 is produced by vulcanizing and molding the green tire 1g produced by the green tire production method 100. In the production method 200 for the pneumatic tire 1, the first step S1 to the third step S3 are the same as those in the green tire production method 100.

In the fourth step S4, the green tire 1g produced through the first step S1 to the third step S3 is placed into a vulcanization mold and vulcanized. Thus, the vulcanized pneumatic tire 1 is produced.

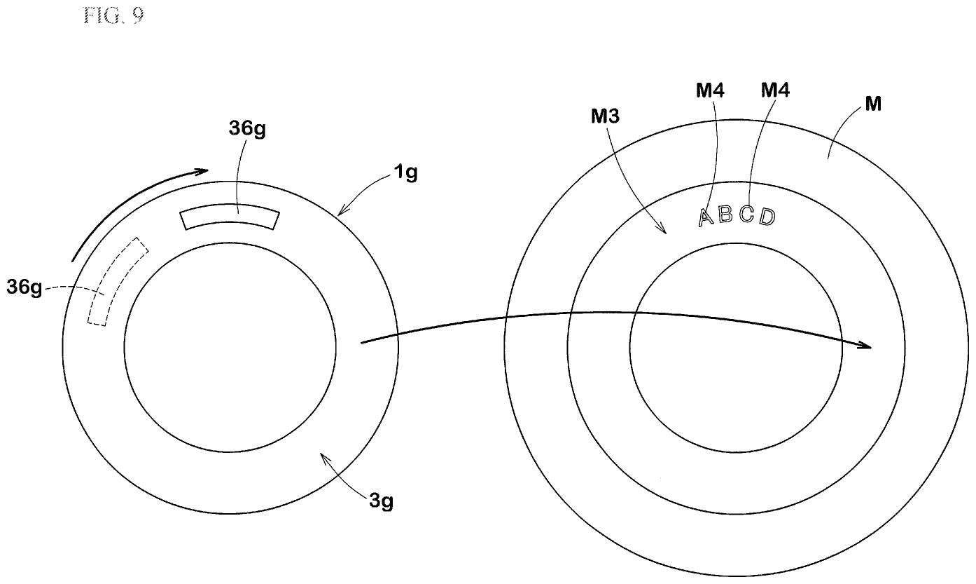

FIG. 9 shows the fourth step S4. A vulcanization mold M for vulcanizing the green tire 1g has a sidewall forming surface M3 for forming the sidewall portion 3 of the pneumatic tire 1, and a recess M4 recessed from the sidewall forming surface M3. The recess M4 is formed in a shape corresponding to the protrusion-like mark 36, and forms the protrusion-like mark 36 on the sidewall portion 3 of the pneumatic tire 1. In FIG. 9, for the convenience of describing the fourth step S4, a cavity space is depicted as seen through the top surface of the vulcanization mold M.

In FIG. 9, the band-shaped rubber 36g before the green tire 1g is rotated is shown by a broken line. In the fourth step S4, when the green tire 1g is placed into the vulcanization mold M, the green tire 1g is rotated around the axis thereof as appropriate. Accordingly, the position of the band-shaped rubber 36g of the green tire 1g and the position of the recess M4 of the vulcanization mold M are aligned with each other. That is, the fourth step S4 includes a step of aligning the band-shaped rubber 36g and the recess M4 with each other. Accordingly, the rubber thickness at the first portion 31 in which the protrusion-like mark 36 is formed in the pneumatic tire 1 is inhibited from being insufficient. In addition, the rubber thickness at the second portion 32 in which the protrusion-like mark 36 is not formed is appropriately maintained.

In the case where a rigid core is used for producing the green tire 1g, in the fourth step S4, the green tire 1g is preferably placed together with the rigid core into the vulcanization mold M. Usually, the rigid core is provided with an encoder for identifying the phase angles of the rigid core and the green tire 1g during the production and vulcanization of the green tire 1g. Therefore, by rotating the green tire 1g together with the rigid core, alignment of the band-shaped rubber 36g and the recess M4 is easily executed. Accordingly, the rubber flow during vulcanization is suppressed, so that the pneumatic tire 1 shaped as designed is easily produced.

FIG. 4 to FIG. 6 show a green tire production apparatus 10 for producing a green tire by executing the green tire production method 100. The green tire production apparatus 10 includes a first mechanism which forms a cylindrical or annular carcass, a second mechanism which winds a sidewall rubber on each of a pair of outer circumferential surfaces of the carcass on the outer side in the axial direction, and a third mechanism 11 which locally attaches a band-shaped rubber to a part of the outer circumferential surface of the sidewall rubber 3g. The first mechanism and the second mechanism of the green tire production apparatus 10 are the same as those of a conventional green tire production apparatus, and thus the illustration and description thereof are omitted.

The third mechanism 11 includes an applicator 12 which conveys the band-shaped rubber 36g to an attachment position P on the green tire 1g.

The applicator 12 includes a cutter 13 for cutting the band-shaped rubber 36g having a long length, a conveyor 14 for conveying the band-shaped rubber 36g, and a pressing roller 15 for pressing the conveyed band-shaped rubber 36g onto the sidewall rubber 3g. Guides 16 are provided on both sides, in the width direction of the band-shaped rubber 36g, of the conveyor 14.

The applicator 12 of the present embodiment is configured such that the position thereof is adjustable in the axial direction and the radial direction of the green tire 1g. Such a configuration is realized, for example, by a mechanism that supports the applicator 12 such that the applicator 12 is movable in the axial direction and the radial direction. Accordingly, the band-shaped rubber 36g is accurately conveyed to the attachment position P on the green tire 1g in executing the third step S3. In addition, it is possible to easily produce multiple types of green tires 1g having different sizes.

The applicator 12 of the present embodiment is configured to be rotatable around the conveyance direction of the band-shaped rubber, thereby making it possible to easily produce multiple types of green tires 1g having different profiles and different sizes.

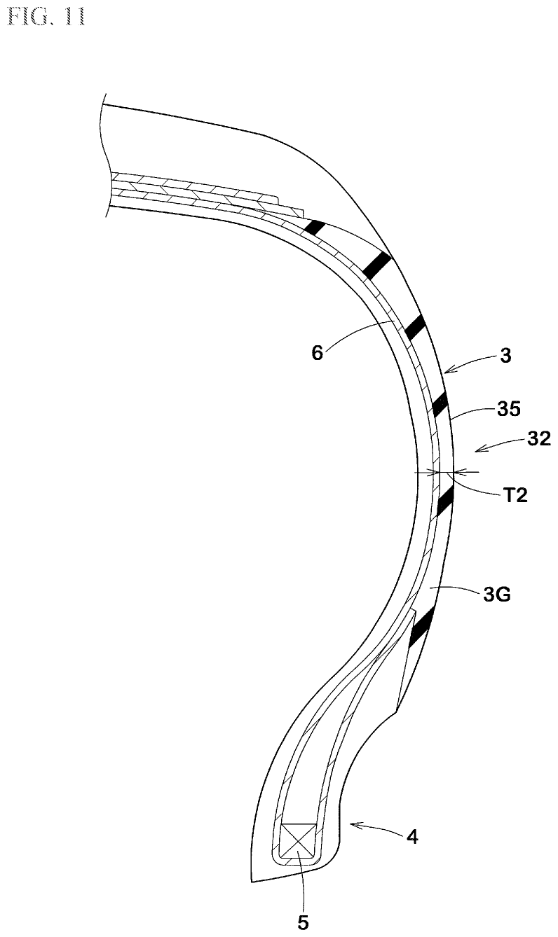

FIGS. 10 and 11 each show a part of a meridian cross-section of the pneumatic tire 1 in FIG. 2. FIG. 10 shows a cross-section X including the first portion 31 in which the protrusion-like mark 36 is formed in the sidewall portion 3, and FIG. 11 shows a cross-section Y including the second portion 32 in which the protrusion-like mark 36 is not formed in the sidewall portion 3.

In the first portion 31, the sidewall virtual contour surface 34 can be drawn. The sidewall virtual contour surface 34 is drawn by smoothly extending a sidewall contour surface 35 of the second portion 32, in which the protrusion-like mark 36 is not formed, to the first portion 31, in which the protrusion-like mark 36 is formed, along the outer surface of the carcass 6.

In the pneumatic tire 1, a first thickness T1 of a sidewall rubber from the outer surface of the carcass 6 at the first portion 31, in which the protrusion-like mark 36 is formed, to the sidewall virtual contour surface 34 is equal to a second thickness T2 of the sidewall rubber from the outer surface of the carcass 6 at the second portion 32, in which the protrusion-like mark 36 is not formed, to the sidewall contour surface 35.

In the pneumatic tire 1 of the present embodiment, the protrusion-like mark 36 is located in a region including a maximum width portion of the pneumatic tire 1. Therefore, in FIG. 10 and FIG. 11, the first thickness T1 and the second thickness T2 indicate the thickness of the sidewall rubber 3G at the maximum width portion. The first thickness T1 and the second thickness T2 are not limited thereto, as long as the positions of the first thickness T1 and the second thickness T2 are the same in the tire radial direction.

Here, the “outer surface of the carcass 6” is intended to be the outer surface of the carcass cords, not including the topping rubber of the carcass 6. The “first thickness T1 is equal to the second thickness T2” is not intended to require equality in the strict sense, but is intended to allow for production errors that are normally assumed for pneumatic tires.

In such a pneumatic tire 1, defects of the sidewall portion 3 caused by an insufficient rubber thickness at the first portion 31 in which the protrusion-like mark 36 is formed are suppressed. In addition, the rubber thickness at the second portion 32 in which the protrusion-like mark 36 is not formed is appropriately maintained, so that an increase in the weight and deterioration of the rolling resistance of the pneumatic tire 1 are suppressed.

In the pneumatic tire 1, the ratio T2/T1 of the second thickness T2 to the first thickness T1 is preferably 90 to 110%.

When the ratio T2/T1 is 90 to 110%, the first thickness T1 and the second thickness T2 are closer to each other, so that the above effects are achieved remarkably.

A height h at which the protrusion-like mark 36 is raised from the sidewall virtual contour surface 34 is preferably 1 to 10 mm.

When the height h is not less than 1 mm, the design properties of the pneumatic tire 1 are enhanced. When the height h is not greater than 10 mm, the uniformity of the pneumatic tire 1 is kept good.

A plurality of protrusion-like marks 36 may be provided on the sidewall portion 3. In this case, the respective protrusion-like marks 36 are preferably evenly distributed in the tire circumferential direction, that is, at an equal angle.

The protrusion-like mark 36 may be formed on each of the pair of sidewall portions 3 on both sides, that is, on each of one sidewall portion 3 and the other sidewall portion 3 in the tire axial direction. In such a pneumatic tire 1, good design properties are obtained without designating an orientation in which the pneumatic tire 1 is mounted to a rim.

Although the green tire production method 100, etc., of the present invention have been described in detail above, the present invention is not limited to the above specific embodiments, and various modifications can be made to implement the present invention.

### EXAMPLES

Fifty pneumatic tires with a size of 37×12.50R20 having the basic structure in FIG. 1 were produced as sample tires on the basis of each type of specifications in Table 1, and were measured for appearance defect, static balance, and weight. The protrusion-like marks of Examples 2 to 4 were evenly distributed in the circumferential direction (e.g., distributed at intervals of 180° in Example 2 and at intervals of 120° in Example 3). The test methods are as follows.

### <Appearance Defect>

The appearance of each protrusion-like mark on the sidewall portions was visually confirmed by an operator. Tires with a good appearance are indicated with good, and tires with a defective appearance are indicated with mediocre. Such defective tires cannot be shipped as products, so that appearance defect is the most prioritized evaluation item.

### <Static Balance>

The static balance of each tire was measured. Tires with a static balance of less than 30 N·cm are indicated with good, and tires with a static balance of 30 N·cm or more are indicated with mediocre.

### <Weight>

The weight of each tire was measured. Tires with a weight of less than 36 kg are indicated with good, and tires with a weight of 36 kg or more are indicated with mediocre.

TABLE 1

| | | Comp. | Comp. | | | | |
|---|---|---|---|---|---|---|---|
| | | Ex. 1 | Ex. 2 | Ex. 1 | Ex. 2 | Ex. 3 | Ex. 4 |
| Protrusion- | Number (upper | 1/1 | 1/1 | 1/1 | 2/2 | 3/3 | 4/4 |
| like mark | type/lower type) | | | | | | |
| | Arrangement | — | — | — | Evenly | Evenly | Evenly |
| | | | | | distributed | distributed | distributed |
| Band- | Presence/ | Absence | Presence | Presence | Presence | Presence | Presence |
| shaped | absence | | | | | | |
| rubber | Arrangement | — | Entire | Local | Local | Local | Local |
| | | | circumference | | | | |

| | | | | | | |
|---|---|---|---|---|---|---|
| Appearance defect | Mediocre | Good | Good | Good | Good | Good |
| Static balance | Good | Mediocre | Mediocre | Good | Good | Good |
| Weight | Good | Mediocre | Good | Good | Good | Good |

As is obvious from Table 1, it is confirmed that the pneumatic tires of the Examples have less appearance defects, better static balance, and lighter weight than those of the Comparative Examples.

### [Additional Note]

The present invention includes the following aspects.

### [Present Invention 1]

A production method for producing a green tire, the production method including:
a first step of forming a cylindrical or annular unvulcanized carcass;
a second step of winding an unvulcanized sidewall rubber on each of a pair of outer circumferential surfaces of the carcass on an outer side in an axial direction; and
a third step of locally attaching an unvulcanized band-shaped rubber to a part of an outer circumferential surface of at least one of the sidewall rubbers.

### [Present Invention 2]

The production method for the green tire according to Present Invention 1, wherein the first step includes a step of attaching unvulcanized tire components including the carcass to an outer surface of a rigid core.

### [Present Invention 3]

A production method for producing a pneumatic tire by vulcanizing the green tire produced by the production method for the green tire according to Present Invention 1, the production method including:
a fourth step of placing the green tire into a vulcanization mold and vulcanizing the green tire, wherein
the vulcanization mold has a sidewall forming surface for forming a sidewall portion of the pneumatic tire and a recess recessed from the sidewall forming surface, and
the fourth step includes a step of aligning the band-shaped rubber and the recess with each other.

### [Present Invention 4]

A production apparatus for producing a green tire, the production apparatus including:
a first mechanism configured to form a cylindrical or annular unvulcanized carcass;
a second mechanism configured to wind an unvulcanized sidewall rubber on each of a pair of outer circumferential surfaces of the carcass on an outer side in an axial direction; and
a third mechanism configured to locally attach an unvulcanized band-shaped rubber to a part in a circumferential direction of an outer circumferential surface of at least one of the sidewall rubbers.

### [Present Invention 5]

The production apparatus for the green tire according to Present Invention 4, wherein the third mechanism includes an applicator configured to convey the band-shaped rubber to an attachment position.

### [Present Invention 6]

The production apparatus for the green tire according to Present Invention 5, wherein the applicator is configured such that a position thereof is adjustable in an axial direction and a radial direction of the green tire.

### [Present Invention 7]

The production apparatus for the green tire according to Present Invention 5 or 6, wherein the applicator is configured to be rotatable around a conveyance direction of the band-shaped rubber.

### [Present Invention 8]

A pneumatic tire including:
a tread portion;
a pair of sidewall portions;
a pair of bead portions in each of which a bead core is embedded; and
a carcass extending between the pair of bead portions so as to straddle the bead cores, wherein
at least one of the sidewall portions has a protrusion-like mark raised from a sidewall virtual contour surface along an outer surface of the carcass and including a letter, a symbol, or a figure,
the protrusion-like mark is formed locally on a part in a circumferential direction of the sidewall portion, and
a first thickness of a sidewall rubber from the outer surface of the carcass at a first portion, in which the protrusion-like mark is formed, to the sidewall virtual contour surface is equal to a second thickness of the sidewall rubber from the outer surface of the carcass at a second portion, in which the protrusion-like mark is not formed, to a sidewall contour surface.

### [Present Invention 9]

The pneumatic tire according to Present Invention 8, wherein a ratio of the second thickness to the first thickness is 90 to 110%.

### [Present Invention 10]

The pneumatic tire according to Present Invention 8 or 9, wherein a height at which the protrusion-like mark is raised from the sidewall virtual contour surface is 1 to 10 mm.

### [Present Invention 11]

The pneumatic tire according to any one of Present Inventions 8 to 10, wherein a plurality of the protrusion-like marks are provided, and are evenly distributed in a tire circumferential direction.

What is claimed is:

1. A production method for producing a green tire, the production method comprising:
a first step of forming a cylindrical or annular unvulcanized carcass;
a second step of winding an unvulcanized sidewall rubber on each of a pair of outer circumferential surfaces of the carcass on an outer side in an axial direction; and
a third step of locally attaching an unvulcanized band-shaped rubber to a part of an outer circumferential surface of at least one of the sidewall rubbers.

2. The production method for the green tire according to claim 1, wherein the first step includes a step of attaching unvulcanized tire components including the carcass to an outer surface of a rigid core.

3. A production method for producing a pneumatic tire by vulcanizing the green tire produced by the production method for the green tire according to claim 1, the production method comprising:
a fourth step of placing the green tire into a vulcanization mold and vulcanizing the green tire, wherein
the vulcanization mold has a sidewall forming surface for forming a sidewall portion of the pneumatic tire and a recess recessed from the sidewall forming surface, and
the fourth step includes a step of aligning the band-shaped rubber and the recess with each other.

4. A production apparatus for producing a green tire, the production apparatus comprising:
a first mechanism configured to form a cylindrical or annular unvulcanized carcass;
a second mechanism configured to wind an unvulcanized sidewall rubber on each of a pair of outer circumferential surfaces of the carcass on an outer side in an axial direction; and
a third mechanism configured to locally attach an unvulcanized band-shaped rubber to a part in a circumferential direction of an outer circumferential surface of at least one of the sidewall rubbers.

5. The production apparatus for the green tire according to claim 4, wherein the third mechanism includes an applicator configured to convey the band-shaped rubber to an attachment position.

6. The production apparatus for the green tire according to claim 5, wherein the applicator is configured such that a position thereof is adjustable in an axial direction and a radial direction of the green tire.

7. The production apparatus for the green tire according to claim 5, wherein the applicator is configured to be rotatable around a conveyance direction of the band-shaped rubber.

8. A pneumatic tire comprising:
a tread portion;
a pair of sidewall portions;
a pair of bead portions in each of which a bead core is embedded; and
a carcass extending between the pair of bead portions so as to straddle the bead cores, wherein
at least one of the sidewall portions has a protrusion-like mark raised from a sidewall virtual contour surface along an outer surface of the carcass and including a letter, a symbol, or a figure,
the protrusion-like mark is formed locally on a part in a circumferential direction of the sidewall portion, and
a first thickness of a sidewall rubber from the outer surface of the carcass at a first portion, in which the protrusion-like mark is formed, to the sidewall virtual contour surface is equal to a second thickness of the sidewall rubber from the outer surface of the carcass at a second portion, in which the protrusion-like mark is not formed, to a sidewall contour surface.

9. The pneumatic tire according to claim 8, wherein a ratio of the second thickness to the first thickness is 90 to 110%.

10. The pneumatic tire according to claim 8, wherein a height at which the protrusion-like mark is raised from the sidewall virtual contour surface is 1 to 10 mm.

11. The pneumatic tire according to claim 8, wherein a plurality of the protrusion-like marks are provided, and are evenly distributed in a tire circumferential direction.
